(19) United States
(12) Patent Application Publication
(10) Pub. No.: US 2012/0034813 A1
(43) Pub. Date: Feb. 9, 2012

(54) APPARATUS FOR REPAIRING WIRING

(75) Inventors: Christopher Fisk, Suffolk (GB); John Andrew Warren, Suffolk (GB); Colin Parkin, Suffolk (GB); Ramon Studd, Suffolk (GB)

(73) Assignee: BRITISH TELECOMMUNICATIONS PUBLIC LIMITED COMPANY, London (GB)

(21) Appl. No.: 13/260,086

(22) PCT Filed: Mar. 25, 2010
(86) PCT No.: PCT/GB2010/000576

§ 371 Date: Sep. 23, 2011

(30) Foreign Application Priority Data
Mar. 27, 2009 (GB) 0905346.3

(51) Int. Cl. H01R 4/26

(52) U.S. Cl. 439/442

(57) ABSTRACT

A crimp for joining copper wires in a telecommunications exchange, the crimp including a cylindrical wall of material comprising an alloy containing copper, iron, nickel, and manganese, and in an embodiment having a composition conforming to BS CN102.

### RELATED APPLICATIONS

The present application is a National Phase entry of PCT Application No. PCT/GB2010/000576, filed Mar. 25, 2010, which claims priority from Great Britain Patent Application No. 0905346.3, filed Mar. 27, 2009, the disclosures of which are hereby incorporated by reference herein in their entireties.

### TECHNICAL FIELD

The invention relates to apparatus for repairing wiring and related aspects. In particular but not exclusively, the invention relates to apparatus, such as a crimp, suitable for repairing wiring in a high density wiring environment where several wires and cables are very close proximity to each other. Such environments include, for example, apparatus for repairing wiring connected to and located within telecommunications exchange apparatus.

### BACKGROUND

High-density wiring environments require wiring and wiring repairs to have characteristics to meet various criteria which may be set by one or more standards bodies for wiring and wiring repairs in a particular environment. The criteria may indicate that wiring repairs have appropriate electrical properties and have certain other physical characteristics, for example, the amount of stress and strain (e.g. compressive, lateral, and longitudinal) the repair is robust against. For example, lateral and longitudinal movement of as well as elongation forces applied to wiring/cabling located in a high-density wiring environment can result in considerable frictional forces being exerted on the cabling (and the wiring housed within cabling) and thus wire repairs in such locations must be appropriately resilient. Examples of high-density wiring environments include duct space and main distribution frames within telecommunications exchanges.

For example, within a telephone exchange, extremely thin diameter wiring (wiring with a cross-sectional area of approximately 1 mm² or less) must be able to withstand a relatively high amount of longitudinal strain (i.e., strain along the longitudinal axis of the wire), for example, 40 Newtowns (N) or more. An idea of the levels of wiring density in a high-density wiring environment can be obtained by considering a typical number of wires per meter squared on the horizontal portion of a main distribution frame (MDF) which can be thousands. An MDF bearer can approximately 500 mm in cross-sectional diameter across with the depth of the jumper wires within the bearer being 200 mm across. On a vertical MDF section there can be between 200 wires per block in a bottom block and 2000 wires per top block (e.g. 200 wires per block×10 blocks). Thus in a high-density wiring environment such as a telephone exchange, where wiring (and repairs to wiring) can also be subject to compressive forces which apply pressure to a wire in an inwards axial direction (for example, compression arising simply from the weight of the surrounding wiring), and where wiring repairs could be deformed/loosened and/or other degrade over time, forming repairs appropriately is extremely important. Any loss of contact between wires in a repair which is detrimental to the electrical transmission characteristics of the wiring can degrade the signal transmission characteristics of the repaired wire resulting in a further repair being required.

Accordingly, in a high-density wiring environment such as a telecommunications exchange MDF, all wiring and wiring repairs are required to have characteristics which to meet certain operational requirements. These repair requirements include those imposed by standard bodies for the telecommunications exchange environment. The wiring is required to meet thermal and conductivity criteria specifications at installation and to maintain performance specifications for these characteristics over a period of time as well as other physical specifications. For example, wiring must not become too brittle as it ages.

Unlike environments in which, when a wire breaks, the choice of method used to repair the wire is determined simply by the most convenient method, the choice of repair method within a telephone exchange environment should therefore meet certain regulatory standards. For example, a repair should result in the repaired joint being sufficiently strong and the repair should not negatively affect the electrical and/or signal transmission properties of the wire to which the repair has been applied and/or electrical and/or signal transmission properties of the surrounding wiring and/or cabling.

To achieve this, it is desirable if a repair can be performed in such a way that the cross-section of the repair joint has a low profile compared to the cross-section of each individual wire being joined so that the join formed by the repair does not increase the outer diameter of the cabling and/or wiring by more than a minimal amount. It is also desirable if the tensile strength of the cabling/wiring is at least maintained at a level comparable with that of each individual wire in the join, so that the repair joint does not form a point of weakness, or focal point, for subsequent breakage if the repaired wire is subsequently to strain.

When a wire or cable breaks in a high wiring density environment where there is very little space between adjacent cables and/or wires and/or wire pairs it is very desirable for the repair to be formed in a manner which restores the wire as closely as possible to its original condition. However, the close proximity of other wires and/or cables means that any repair must be capable of being carried out in a small space and ideally result in a repair which does not dramatically increase the diameter of the wire/cable at the break point (as this could cause the cable to catch or snag when being moved longitudinally and/or affect adjacent wiring) and ideally ensure that the repaired wire maintains a relatively high tensile strength compared to its original tensile strength. If not, then there is a chance that the wire will simply break again at the point of the repair if subjected to a similar amount of strain as that which caused the break in the first place.

United States Patent Application US2002/0057985 entitled “Copper Alloys for use as connector materials having high resistance to stress corrosion cracking and a process for producing the same” describes an copper alloy suitable for use as a connector material which has sufficient strength to withstand crimping which contains 17-32 wt % Zn, Sn and SI and lists a range of other contents whose sum is 0.01 to 5 wt %, provided that S is present in an amount up to 30 ppm, the elements comprising at least one of the group consisting of: 0.01-3 wt % Fe, 0.01-5 wt&Ni, 0.01-3 wt % Co, 0.01-3 wt % Ti, 0.01-2 wt % Mg, 0.01-2 wt % Zr, 0.01-1 wt % Ca, 0.01-10% wt Mn, 0.01-3 wt % Cd, 0.01-5 wt % Al, 0.01-3 wt % Pb, 0.01-3 wt % Bi, 0.01-3 wt % Be, 0.01-1 wt % Te, 0.01-3 wt % Y, 0.01-3 wt % La, 0.01-3 wt % Cr, 0.01-3 wt % Ce, 0.01-5 wt % Au, 0.01-5 wt % Ag and 0.01-5 wt % P.

U.S. Pat. No. 4,442,182 describes a one-piece composite electrical connector having a cast-aluminium bronze alloy CDA 955 at the mechanical connection end which includes as a percentage of the alloying elements in copper 10.0 to 11.5% Al, up to 3.5% Mg, 3.0 to 5.0% Fe, and 3.0 to 5.5% Ni.

International Patent Application WO01/68928 describes Be—Cu alloys including Be, Ni and/or Co, Pb, and Cu alloy components with respective operable wt % of 0.15 to 0.5, 0.40 to 1.40, 0.2 to 1.0, balance; respective typical wt % of: 0.2 to 0.4, 0.5 to 1.25, 0.2 to 0.60, balance; and respective more typical wt % of 0.25 to 0.35, 0.60 to 0.80, 0.25 to 0.50, and balance. In addition, the alloys can contain a total of 0.50 wt % of one or more of the following ingredients, typically as impurities: Fe, Al, Si, Cr, Zn, Sn, Ag, Mn, Mg, Ti, and Zr.

European Patent Application EP 10505094 entitled “Copper Alloy with improved resistance to cracking” describes a copper alloy having improved resistance to cracking due to localized plastic deformation. The alloy consists essentially of: from 0.7 to 3.5 weight percent nickel; from 0.2 to 1 weight percent silicon; from 0.05 to 1 weight percent tin; from 0.26 to 1 weight percent iron; and the balance copper and unavoidable impurities. The copper alloy has a local ductility index of greater than 0.7 and a tensile elongation exceeding 5%.

EP10505094 further describes one alloy in which nickel is from 1.2 to 2.8 weight 10 percent, silicon is from 0.3 to 0.7 weight percent, tin is from 0.2 to 0.6 weight percent, iron is from 0.28 to 0.7 weight percent and the alloy further includes an effective amount of manganese for improving hot workability up to 0.15 weight percent and another alloy in which nickel is from 1.5 to 2.5 weight percent, silicon is from 0.35 to 0.55 weight percent, tin is from 0.3 to 0.5 weight percent, iron is from 0.3 to 0.5 weight percent and manganese is from 0.02 to 0.1 weight percent.

### SUMMARY OF THE INVENTION

Embodiments provide methods and means to repair wiring, particular, copper wiring locating in a high-density wiring environment, in which the resultant repair was found to have unexpectedly improved properties over known repair apparatus and methods for such environments. Embodiments are useful for repairing one or more of a plurality of wires located in a high wiring density environment where it is important that the external diameter of the cabling sheath is increases as little as possible by the repair. Such high-density wiring environments include cables comprising a plurality of wires housed within a cabling sheath, such as, for example, the cables which run within and to and from a telephone exchange main distribution frame. In addition, the material used to form a repair to copper wiring according to embodiments is sufficiently malleable enough to permit forming the repair without exerting too much compressional force. Exerting too much compression when forming the crimp could affect the conductive properties of the repair, for example, by damaging the wires by overly reducing the cross-sectional area of the wiring within the repair or even severing a wire) when using a crimping tool.

A crimp joint according to embodiments comprises deformed material (i.e. the compressed or crimped material) which forms the repair resulting in a repair joint which has a narrow cross-sectional area but which is strong enough to withstand additional compressive forces and lateral strain exerted by movement of the repaired wiring or by the movement of other elements which come into contact with the wiring.

Thus at least one of the various embodiments seeks to provide a method of repairing wiring in a high-density wiring environment such as a telephone exchange, in particular, but not exclusively for repairing the wiring which is connected to and runs within a main distribution frame in a telephone exchange environment.

By experimentation, an alloy has been found for constructing of cylindrical crimps which comprises a copper, iron, manganese, and nickel alloy composition. As the material properties are very suitable for forming tubular or cylindrical crimps, not only is the method of manufacturing the crimps very simple, but in addition, the crimps can be formed to have dimensions which make them very suitable for repairing electrical wiring in high-density wiring environments where frictional forces can be applied to repaired joints as well as compression forces. The material was found to yield quite unexpected results which met the criteria for crimp repairs to wiring in a telecommunications MDF environment, and to any other environment where wiring is present in very high wiring densities.

Embodiments seek to obviate and/or mitigate unnecessary wastage of material and enable a faster repair to be performed than in known in the art.

Embodiments are as set out below and by the accompanying claims. Embodiments also comprise any suitable combination of the various embodiments which are apparent to those of ordinary skill in the art.

Embodiments seek to provide a crimp joint forming an electrical connection between two electrically conductive wires, the crimp joint comprising a crimp comprising a cylindrical tube of material composed of an alloy comprising copper, iron, nickel and manganese, wherein, within the tubular portion of the crimp body, a length of the first end of one of the wires is adjacent to a length of the other wire to overlap with the other wire in a longitudinal direction within the cylindrical crimp body.

The crimp can comprise a substantially copper alloy including about 10 to 13% by weight in total of iron, nickel and manganese. The iron can be present in quantities of about 9 to 10% wt. The nickel can be present in quantities of about 1 to 2% wt. The manganese can be present in quantities of about 0.3 to 1% wt.

The electrically conductive wires can have a substantially copper composition.

Each of two electrically conductive wires can remain fixedly attached at a far end when a near end of each wire is inserted into cylindrical crimp body, and wherein the near end of each wire is inserted into the same aperture of crimp body.

Each of two electrically conductive wires remains fixedly attached at a far end when a near end of each wire is inserted into cylindrical crimp body, and wherein the near end of each wire is inserted into a different aperture of crimp body and each wire is pushed into cylindrical crimp body sufficiently far to overlap with the other wire along the longitudinal axis of the crimp body.

The electrically conductive wires can lie substantially parallel to each other along the entire length of the crimp body.

The crimp can be comprised of an alloy having a manganese content of the alloy comprises 0.3 to 1% by weight of the alloy content.

The crimp joint can be comprised of an alloy which comprises about 90% copper and 10% of an alloy of iron, nickel and manganese. The alloy can consist only of copper, iron nickel and manganese. The quantities can vary by a small fraction of the stated values or be exact.

Trace quantities of elements can be present, for example, as impurities. The crimp joint can be comprised of an alloy of iron, nickel and manganese which comprises about 9 to 11% iron, 1 to 2% nickel, and 0.3 to 1% manganese. The quantities can vary by a small fraction of the stated values or be exact. Trace quantities of elements can be present, for example, as impurities.

The crimp joint can be composed of an alloy conforming to the CN102 BS composition.

The crimp joint can have an internal diameter of 1.1 mm in cross-section.

Each of the wires in a crimp can have a cross-sectional area of 1 mm², and the external diameter of the joint formed by the crimp around the two wires of 1 mm² which overlap along the longitudinal axis of the cylindrical body of the crimp can range between 1.35 and 1.39 mm.

The thickness of the cylindrical wall of the crimp body can range between 0.35 and 0.39 mm.

The crimp joint can be used to repair a severed wire in a telecommunications exchange.

Each wire end can substantially comprise copper and have a diameter of at least 1 mm². The external diameter of the crimp joint can range between 1.35 and 1.39 mm. The crimp joint can retain each wire when one, each or both wires are subjected to a tensile force of at least 50N. Each wire can be subjected to a tensile force of at least 51N. Each wire can be subjected to a tensile force of at least 51.5N.

The crimp joint can be in a telecommunications exchange and each wire can be provided as a wire in a cable comprising a plurality of wire pairs. Each wire in the cable can be able to resist a pull-out force of 51N applied in a longitudinal direction along the crimp joint. Each wire can be connected at one end to a main distribution frame in telecommunications exchange. The plurality of wire pairs can comprise five wire pairs.

In an embodiment, a crimp for use in forming a crimp joint comprises a cylindrical tube of material composed of an alloy comprising copper, iron, nickel and manganese, and is capable of receiving within the tubular portion of the crimp body at least two wires.

The alloy can have a composition conforming to the British Standard CN102.

### BRIEF DESCRIPTION OF THE DRAWINGS

Embodiments will now be described with reference to the accompanying drawings which are by way of example only and in which:

FIG. 1 shows a schematic view of a main frame in a telecommunications exchange according to an embodiment.

FIG. 2A shows schematically a crimp joint rejoining the ends of two wires having a first wiring repair configuration according to an embodiment.

FIG. 2B shows schematically the crimp joint shown in FIG. 2A with the joined ends of the wires removed according to an embodiment.

FIG. 2C shows schematically a crimp joint rejoining the ends of two wires having a second wiring repair configuration according to an embodiment.

FIG. 2D shows schematically the crimp joint shown in FIG. 2C with the protruding ends of the rejoined wires removed according to an embodiment.

FIG. 2E shows schematically a cross-section through a crimp joint as shown in any of FIGS. 2A to 2D according to an embodiment.

FIG. 2F shows a cross-sectional view of the wiring within a cable comprising five pairs of wires according to an embodiment.

FIG. 3A shows a side-ways schematic view of a section of a cable 16 repaired according to an embodiment.

FIG. 3B shows an enlarged schematic side-ways view of the location of a wire fault in a cable 16 according to an embodiment.

FIG. 4A shows an enlarged schematic side-ways view of a crimp joint repairing in situ the wire fault in a cable 16 shown in FIGS. 3A and 3B according to an embodiment.

FIG. 4B shows an enlarged schematic cross-sectional view of the crimp joint shown in

FIG. 4A according to an embodiment.

FIG. 4C shows schematically an enlarged view of the cross-section shown in FIG. 3C according to an embodiment.

### DETAILED DESCRIPTION

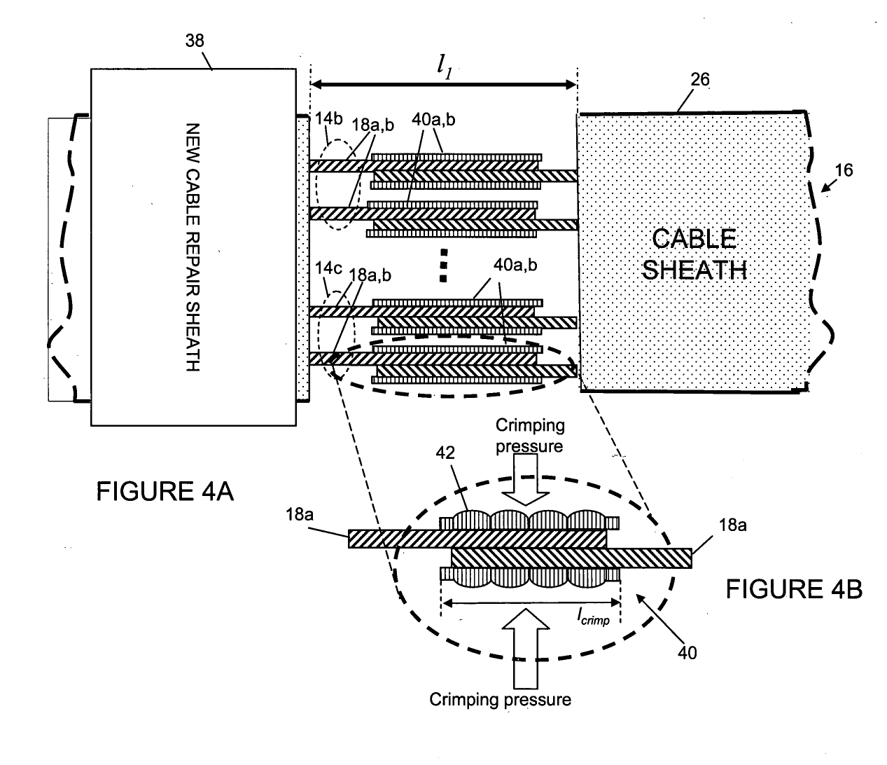

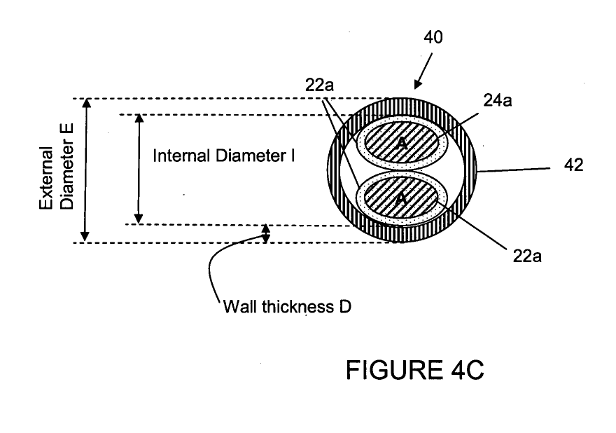

Those of ordinary skill in the art will be aware that for clarity the description may omit to directly refer to features of embodiments whose inferred presence is apparent to one of ordinary skill in the art. Elements of embodiments shown in FIGS. 4A, B, and C retain the numbering scheme shown in the previous drawings.

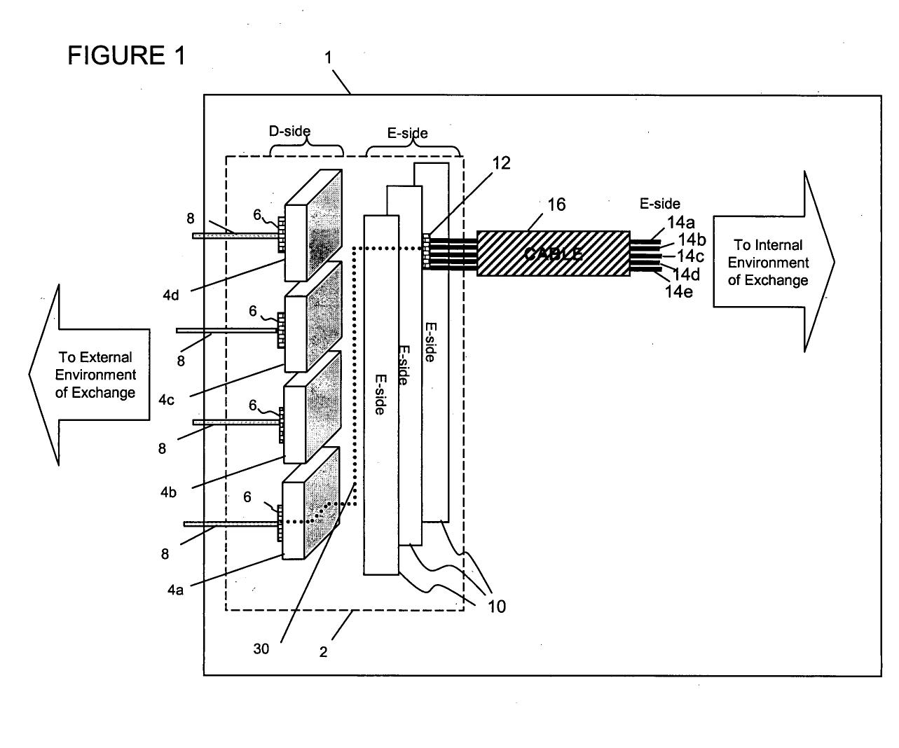

FIG. 1 of the accompanying drawings shows as an example of a high-density wiring environment 1, a telephone exchange comprising an MDF 2. A typical MDF 2 in a telephone exchange can support the termination of hundred of thousands of connections to the premises of telecommunications service subscribers, although only a few are shown for the sake of clarity in FIG. 1. Most subscriber premises receive telecommunications services via a pair of copper wires which run from the local exchange to the subscriber premises. As a result, at the local exchange, hundreds of thousands of wires have to be accommodated and to do this the wires are packed tightly together, which forms the high-density wiring environment 1 in which duct space is very limited. The term high-density wiring environment is defined herein to imply an environment in which a sufficient amount of wires and/or cables are confined to a predetermined area to result in the movement of any one wire and/or cable resulting in a pressure change on one or more adjacent wires and/or cables.

In FIG. 1, MDF 2 has on a “D-side” a series of horizontal banks 4a . . . 4d of termination blocks 6 on one side of a supporting frame (not shown) receives wiring 8 which comprises pairs of copper wires which connect subscriber premises to the exchange via an access network (not shown). On the other side of the frame, known in the art as the “E-side” of MDF 2, a series of vertical arrangements 10 of termination blocks 12 are provided to connect wiring to other equipment housed within the exchange via which other communications networks can be accessed. As shown in FIG. 1, the wiring from the E-side of the MDF comprises a plurality of cables. In a typical UK telephone exchange environment, five wire pairs 14a,b,c,d,e are bundled together to form a cable 16. Within the MDF, a jumper 30 comprising a twisted pair of copper wires form an internal connection between the D-side termination blocks 6 and the E-side termination blocks 12 for each subscriber.

As the duct space is so limited the wires and cables in a cable run/duct are so tightly packed that it is not normally possible to remove a long stretch of wire/cable if that wire/cable is damaged and/or is cut in two. Accordingly, it is very important for the wire/cable to be repaired effectively in situ and for the repaired wire to have as low a profile as possible, to ensure that it is less likely to snag on something if moved. In addition, it is important that the repair is as strong as possible against “pull-out” forces, these being forces which compel the wires to moved in such a way that they would soon work loose from any join repairing them.

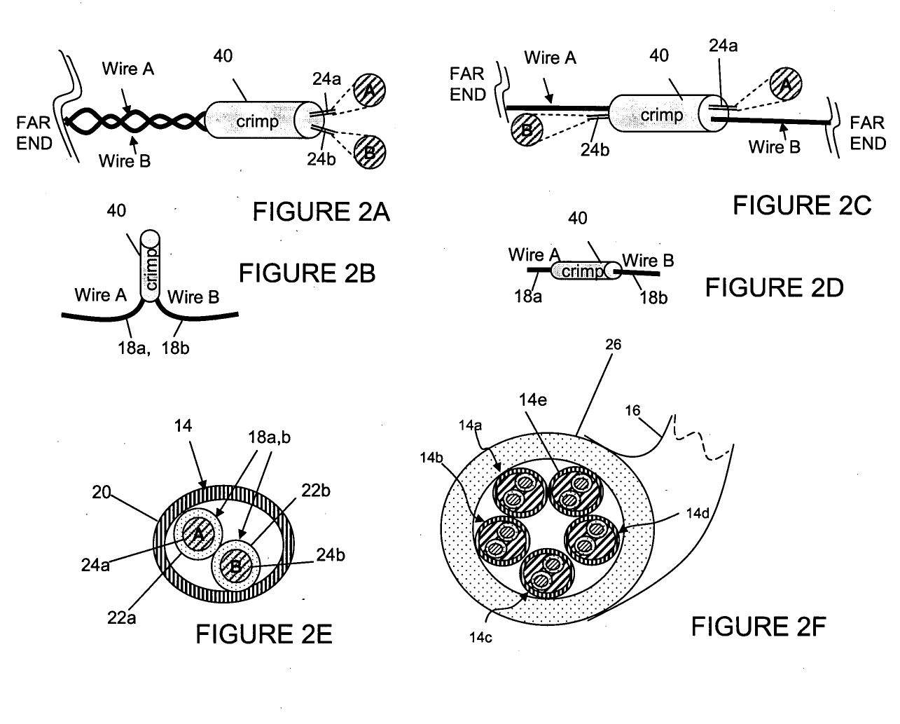

Two different wiring configurations can be repaired using a crimp which permits the wires which are to be joined to overlap each other in a longitudinal direction within the crimp joint formed, for example, contrast the embodiment of a crimp joint shown in FIGS. 2a,b with the embodiment of a crimp joint shown in FIG. 2c,d respectively.

FIGS. 2A to 2E show a crimp joint which comprises a cylindrical crimp 40 which is used to join two wires 18a, 18b referred to also in the drawings as Wire A and Wire B. Wire A 18a comprises a copper core wire 24a surrounded by an insulating sheath 22a. Wire B 18b comprises a copper core wire 24b surrounded by an insulating sheath 22b.

In FIG. 2A, the insulating sheath 22b has been removed from the ends of the two wires 18a, 18b, to expose the cooper cores 24a,24b and the exposed ends are slid into the same end of crimp 40 so that exposed copper wires 24a, 24b lie alongside each other aligned generally along the longitudinal axis of the crimp 40 according to an embodiment. The exposed ends of the two wires 24a, 24b are in electrical contact with each other and the cylindrical body of the crimp 40. In an embodiment, the crimp joint is formed by exerting pressure laterally on the crimp body, for example, by using a KNIPEX [trade] crimp tool. FIG. 2B shows a resultant crimp joint, in which the ends of the copper wires A, B have been cut away so that all exposed copper is within the crimp 40. Not shown in FIG. 2a or 2b is the presence of an insulating sheath which would be placed around the crimp 40 to ensure its electrical isolation from other potential electrical contacts.

FIG. 2C shows an alternative embodiment in which the crimp joint is formed by sliding the two wires in opposing directions into the body of the crimp 40 so that the exposed copper cores 24a, 24b lie alongside each other aligned generally along the longitudinal axis of the crimp 40. The exposed ends of the two wires 24a, 24b are in electrical contact with each other and the cylindrical body of the crimp 40. In an embodiment, the crimp joint is formed by exerting pressure laterally on the crimp body, for example, by using a Knipex™ crimp tool. FIG. 2B shows a resultant crimp joint, in which the ends of the copper wires A, B have been cut away so that all exposed copper is within the crimp 40. Not shown in FIG. 2a or 2b is the presence of an insulating sheath which would be placed around the crimp 40 to ensure its electrical isolation from other potential electrical contacts.

Within the telecommunications exchange high-density wiring environment 1 shown in FIG. 1, the crimp is suitable for use in repairing jumper wires, or copper twisted pair. The crimp joint shown in FIG. 2d is formed in longitudinal alignment with the two copper wires it is repairing and therefore has less of a chance of snagging.

FIG. 2E shows an expanded cross-sectional view of a pair of wires such as that shown above in FIG. 2A. In FIG. 2E, a wire 14 comprises a twisted copper pair of wires 18a,18b which are enclosed within an insulating sheath 20. Each individual wire 18a, 18b comprises an insulating sheath 22a,22b respectively surrounding a signal conducting core 24a,24b respectively.

FIG. 2E shows an expanded cross-sectional view of cabling 16 shown in FIG. 1. As shown in FIG. 1, cable 16 comprises an insulating sheath 26 surrounding five wire pairs 14a, . . . , 14e. As shown in FIG. 1, cable 16 runs from other equipment located in the exchange to the E-side of the termination block 12 of MDF 2. In FIGS. 1 and 2F, cable 16 is shown in cross-section as comprising five pairs of copper wires 14a,b,c,d,e known in the art as a five-pair fan-out tail. Each wire pair 14 forming a five-pair fan-out tail is terminated at a termination point 12 as shown in FIG. 1 using individual termination points. An example of an E-side termination block 12 is a JT47 block and a wire pair 14 typically has a sheath 20 diameter of approximately 0.1 mm² in cross-sectional area.

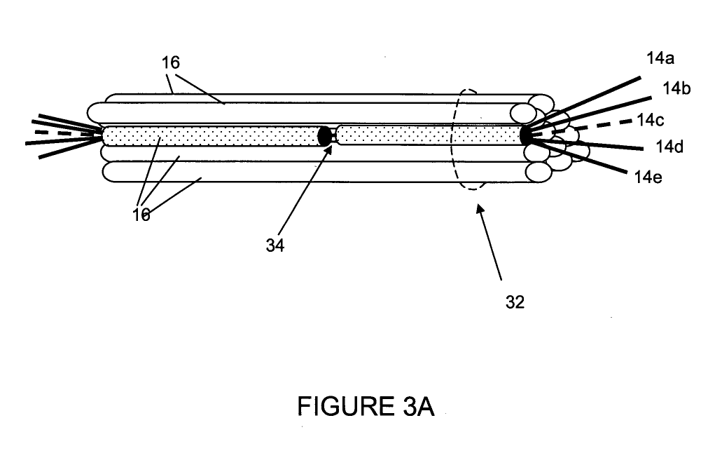

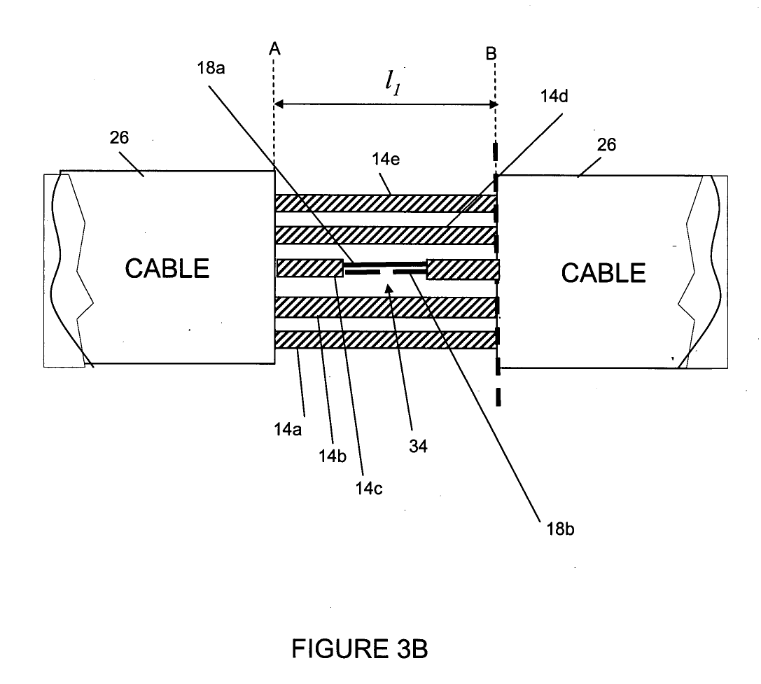

FIG. 3A is a schematic diagram showing a high wiring density environment 32 in which a plurality of cables 16 are packed tightly together, for example, within a cable run or duct (not shown). FIG. 3A shows an exemplary fault 34 affecting wire pair 14c (shown emerging from the cable as a dashed line in FIG. 3A) which requires one or more wires located within a cable 32 to be repaired. FIG. 3B shows a cross-section of a cable 16 housing a faulty wire 18b in which a length l₁ of the cable sheath 26 has been cut away to expose the faulty wire 18b.

FIG. 4A shows again the break of length l₁ in the cable sheath 26 of cable 16 which has been removed to provide access to repair the faulty wire 18b. In order to comply with regulations, the sheath of cable 16 can be repaired using a cylindrical section of material shown in FIG. 4A as new cable repair sheath 18, which requires all of the wire pairs 14a . . . 14e housed by cable 16 to be severed. FIG. 4A shows two of the wire pairs 14b and 14c which have been repaired using a crimp according to an embodiment.

As shown in FIG. 4A, a cylindrical, tubular, crimp 40 is used to re-join the severed ends of a wire. FIG. 4B shows in more detail a side-ways cross-section of a crimp joint of length l_{crimp} which is joining the two severed ends of wire 18a according to an embodiment.

The crimp joint shown in FIG. 4B was formed by a crimping tool which exerts crimping pressure at a plurality of pressure points spaced distally along the longitudinal axis of the crimp, for example, the KNIPEX [trade] 97 52 08 crimp tool can be used to form the crimp joint.

The crimp according to an embodiment comprises a copper, nickel and manganese metal alloy. For example, in an embodiment the composition of the alloy comprises 90% copper and 10% nickel-iron alloy by weight. The copper-nickel-iron alloy can comprise 9-11% wt nickel, 1-2% wt (e.g. 1 to 1.8% wt) iron, which trace amounts of manganese, for example, 0.3 to 1.0% wt (e.g. 0.5-1.0% wt) manganese with the remainder copper. Very small quantities of lead and trace impurities can be present. In an embodiment, the alloy has the CN102 BS specification or equivalent. CN102 BS is a copper nickel iron alloy with a small alloy content of manganese.

BS2874 CN102 has the ISO designation CuNi10Fe1Mn and has the international equivalents EN12163 CW, 352H ASTM, B121 C70600. Its chemical composition is listed by Wt. % and is given as Ni % 10-11, Mn % 0.5-1, Fe %1-2, Pb 0-0.01%, Impurities 0.3 max, with the remainder Cu %. In an embodiment, the crimp has this chemical composition.

This alloy is known to have excellent resistance to sea and brackish water and combines easy fabrication with good mechanical properties between −100 and 300 degrees Celsius. The iron and manganese content of the alloy improve the mechanical properties and its resistance to corrosion and erosion. This material has been found to be sufficiently malleable and to have a sufficient tensile strength to enable its extrusion about a bore into a tubular or cylindrical form from which, by severing lengths of the extruded material, cylindrical crimps can be obtained which have surprisingly useful material properties suitable for the purpose of repairing copper wires.

FIG. 4C shows in more detail a cross-section through crimp joint 40. The crimp joint 40 shown in FIG. 4C comprises a cylindrical sheath 42 of the crimp which forms a boundary around the ends of wire 18a. Each severed part of wire 18a is placed within the crimp joint 40 so that they overlap with each other along the longitudinal direction of the crimp joint within the crimp sheath 42. This shortens the severed part of wire 18a by at least l_{crimp}.

The crimp which is shown in a used state in FIG. 4C has an overall external diameter E, and internal diameter I, and a sheath thickness D. Typical figures for a crimp joint formed according to an embodiment are:

E=1.45 to 1.49 mm

I=1.0 to 1.1 mm

D=0.35 to 0.49 mm.

Thus, a crimp according to an embodiment has sufficient deformability and strength to enable the overlapping ends of the wires being repaired within the crimp to be suitably compressed when forming the crimp joint.

The crimp was subject to an accelerated aging testing using test conditions which heated a crimp joint in a range of dry and humid conditions at various temperatures. For example, a crimp was subjected to a test cycle of 20 hours dry at 70° C., followed by 4 hours at 40° C. and 93% relative humidity (RH), for four cycles, to give the overall test conditions of 80 hours in 70° C. dry heat and for 16 hours at 40° C. with a relative humidity of 93%.

The results of the initial electrical resistance and the aged sample resistance for two copper wires of approximately 1 mm² cross-sectional area repaired with a crimp having a 1.1 mm internal diameter I according to an embodiment are shown in Table 1 below.

TABLE 1
resistance of aged samples.

| | | Resistance of |
|---|---|---|
| | Initial Resistance | Aged Sample |
| Sample Number: | (mΩ) | (mΩ) |
| 1 | 13.53 | 14.51 |
| 2 | 13.16 | 15.89 |
| 3 | 13.58 | 26.48 |
| 4 | 12.92 | 14.54 |
| 5 | 13.62 | 26.04 |

Table 1 shows the resistance in milliohms (mΩ) of a 150 mm sample length of a copper wire 18a,b such as is known in the art to form a wire pair 14, where 5 wire pairs form a fan-out tail in a telephone exchange and before repair have a resistance of 12 mΩ. The initial resistance is the resistance of the 150 mm repaired jumper just after the repair is formed is shown in Column 2 and the aged resistance shown is the resistance after the full 80 hour test cycle as described herein above. The resistances shown comprise the overall resistance of the wires when repaired using a crimp according to an embodiment, for example a crimp comprising the CN102 metal alloy or other copper-iron alloy comprising a 0.1 to 1% manganese, and in an embodiment 0.3 to 1% manganese alloy content.

A repair joint formed using a crimp having a copper-iron-manganese alloy composition such as CN102 according to an embodiment was also tested for breakage when subjected to a pull-out force.

In an embodiment a crimp having a 1.1 mm internal diameter is used to form a crimp around two copper wires of approximately 1 mm² cross-sectional area. The results are set out below in Table 2 for a set of five-wire samples forming a typical 5 pair fan-out tail in a high-density environment such as a telephone exchange. The wires each have slightly differing electrical resistances which were subject to a tensile force along the longitudinal axis of the wires (a “pull-out force”):

TABLE 2
pull-out force for a five-pair fan-tail repaired
by a crimp according to an embodiment.

| Sample Wire | Resistance (mΩ) | Pull-Out Force (N) |
|---|---|---|
| 1 (blue) | 12.42 | 57.5 |
| 2 (orange) | 12.47 | 56.5 |
| 3 (green) | 12.59 | 53.0 |
| 4 (brown) | 12.54 | 54.7 |
| 5 (slate) | 12.44 | 51.6 |
| High | 12.59 | 57.5 |
| Average | 12.49 | 54.66 |
| Low | 12.42 | 51.6 N (Lower limit |
| | | (80%) = 41.44 N) |

Table 3 below shows for comparison the forces exerted on the crimp joint according to an embodiment which was used to repair wires in a fan-tail compared to the forces at which a crimp joint having the same internal diameter but a different composition broke at when subjected to strain.

The wire colors in Table 1 refer to the wires in an exemplary fan-tail in a telephone exchange environment. The crimps were all formed using the KNIPEX [trade] crimp tool.

TABLE 3
comparison of pull-out forces exerted
on crimps of different composition.

| | | Tensile strength of |
|---|---|---|
| | Copper wire | copper wire = |
| Copper Butt | Resistance without | 51.8 N |
| standard crimp | crimp = 12.35 m\acute{ }Ω | Pull out/break |
| Wire Colour | Resistance (m\acute{ }Ω) | force (N) |
| Blue | 12.7 | 57.9 |
| Orange | 12.46 | 56.1 |
| Green | 14.92 | 44.5 |
| Brown | 15.30 | 56.7 |
| Slate | 12.69 | 54.3 |
| High | 15.30 m\acute{ }Ω | 57.9 N |
| Average | 13.614 m\acute{ }Ω | 53.9 N |
| Low | 12.46 m\acute{ }Ω | |
| CN102 crimp | | |
| drilled 1.1 mm | | |
| through joint | | |
| Wire Colour | Resistance (m\acute{ }Ω) | Pull out force (N) |
| Blue | 12.42 | 57.5 |
| Orange | 12.47 | 56.5 |
| Green | 12.59 | 53.0 |
| Brown | 12.54 | 54.7 |
| Slate | 12.44 | 51.6 |
| High | 12.59 m\acute{ }Ω | 57.5 N |
| Average | 12.49 m\acute{ }Ω | 54.66 N |
| Low | 12.42 m\acute{ }Ω | |
| Brass Crimp drilled | | |
| 1.1 mm. Through | | |
| joint | | |
| Blue | 12.42 | 50.6 |
| Orange | 12.74 | 45.1 |
| Green | 13.25 | 49.1 |
| Brown | 12.41 | 53.0 |
| Slate | 12.42 | 50.6 |
| High | 13.25 m\acute{ }Ω | 53.0 N |
| Average | 12.648 m\acute{ }Ω | 49.68 N |
| Low | 12.41 m\acute{ }Ω | |
| Brass Crimp drilled | | |
| 1.1 mm through | | |
| joint. | | |
| Wire stripped with | | |
| ITT cannon cable | | |
| stripper 9 mm long | | |
| Blue | | 56.3 |
| Orange | | 50.8 |
| Green | | 54.1 |
| Brown | | 56.7 |
| Slate | | 57.1 |
| High | | 57.1 N |
| Average | | 55.0 N |
| Low | | |

The average pull-out force which broke a wire using a crimp comprising an alloy according to an embodiment is the second highest shown above. A crimp according to an embodiment also enabled all of the wires to withstand a higher force than any of the other crimps, for example, the lowest force at which a wire repaired using a crimp according to an embodiment broke at was 51.6 N.

The inventor has thus found that a crimp having an approximately 90% copper 10% iron by weight metal alloy composition which contains a small quantity of manganese (in an embodiment 0.3 to 1%) and which has a wall thickness of 0.35 to 0.39 wall thickness and an internal cross-sectional diameter of 1.1 mm is sufficiently strong to withstand a pull-out force of over 50N, and in an embodiment over 51N, and in another embodiment over 51.6N when used to repair copper wires of 1 mm² for a longitudinal crimp cylinder length of 10 mm.

The CN102 British Standard alloy is known for use in marine environments as the manganese content provides corrosion resistance in salt and brackish water, and is also known for use in fishing tackle. The CN102 alloy is based on copper and nickel with the minor addition of iron and manganese and is noted for its resistance to withstand sea water corrosion and erosion. The CN102 alloy is used widely for example in heat exchangers cooling plants, desalination treatment plants and other water treatment plants. The inventor found that by repurposing fishing tackle to have dimensions suitable for use as a crimp in a telecommunications exchange environment, the crimp joints formed had physical properties which were particularly advantageous when compared to crimps formed from more conventional materials, and which could be manufactured more cheaply.

Expressions of the type “about ‘X’ value” as used herein in the description and claims are provided to indicate that the quantity ‘X’ results in the unexpected and advantageous properties provided by the various embodiments described herein and that other quantities comprising ‘X’ varied slightly by a small fraction can nonetheless also result in the unexpected and advantageous properties enabling the features of embodiments to be retained. Thus the expression about 10% of ‘X’ includes 10% plus or minus a small fraction of 10%, for example, 9.5% to 10.5%.

Expressions which indicate an alloy consists of certain percentages of elements by weight can also refer to alloys which include the present of other trace elements as impurities even when no explicit reference is made to refer to such trace elements. In addition or in the alternative, an alloy which consists of certain percentages of elements by weight can also include trace elements which have no effect on the material properties of the alloy from a crimping perspective. Such trace elements will ideally be present as less than 0.1% wt.

The crimp body is provided substantially in a cylindrical form consisting of a hollow elongated shape with at least one and, in an embodiment, two open ends through which a pair of wires can pass. It can be formed by suitably extruding a longer cylinder of material and segmenting this into a number of shorter sections. Alternatively individual crimps could be formed by moulding either individual crimps or a longer cylinder and segmenting this into sections. Alternatively, a sheet of material could be rolled or otherwise deformed into an appropriately cylindrical form, either to form an individual crimp or to create a longer cylindrical which can be segmented into a plurality of crimps using any suitable method.

A cylindrical form can have a circular or non-circular (e.g. triangular, square or other polygonal shape) in cross-section and the form need not be uniform along the length of the cylinder (although in practice the form is likely to be substantively the same along the length of the cylinder).

It is possible to also provide a crimp as a sheet material or as material provided in an unclosed cylindrical form which is then deformed in situ around wiring to form a cylindrical crimp joint wiring repair according to embodiments.

In this way, however, a crimp can be manufactured and/or provided in situ which consists only of a cylindrical body surrounding the wiring to be crimped.

The invention as described herein includes references to features which can be modified in ways apparent to those of ordinary skill in the art and the scope of the invention as defined by the claims includes such apparent modifications and known functional equivalents to the features of the invention described herein unless explicit reference is made to the contrary.

1. A crimp joint forming an electrical connection between two electrically conductive wires, the crimp joint comprising:
a crimp comprising a cylindrical tube of material comprising an alloy comprising copper, iron, nickel and manganese, wherein, within the tubular portion of the crimp body, a length of the first end of one of the wires is adjacent to a length of the other wire to overlap with the other wire in a longitudinal direction within the cylindrical crimp body,
wherein the crimp is comprises a substantially copper alloy including:
nickel in quantities of about 9 to about 11% weight (wt),
iron in quantities of about 1 to about 2% wt,
manganese in quantities of about 0.3 to about 1% wt, and
lead in quantities of up to about 0.1% wt.

2. A crimp joint as claimed in claim 1, wherein
the iron is present in quantities of about 1 to about 1.8% wt,
the nickel is present in quantities of about 9 to about 11% wt, and
the manganese is present in quantities of about 0.5 to about 1% wt.

3. (canceled)

4. A crimp joint as claimed in claim 1, wherein the lead is present in quantities of up to about 0.01% wt.

5. A crimp joint as claimed in claim 1, wherein each of the two electrically conductive wires remains fixedly attached at a far end when a near end of each the wire is inserted into the cylindrical crimp body, wherein either:
the near end of each wire is inserted into the same aperture of the crimp body; or
the near end of each wire is inserted into a different aperture of the crimp body and each wire is pushed into the cylindrical crimp body sufficiently far to overlap with the other wire along the longitudinal axis of the crimp body.

6. A crimp joint as claimed in claim 5, wherein the electrically conductive wires lie substantially parallel to each other along an entire length of the crimp body.

7. A crimp joint as claimed in claim 1, wherein the crimp joint is used to repair a severed wire in a telecommunications exchange.

8. A crimp joint as claimed in claim 1, wherein
each wire end substantially comprises copper and has a diameter of at least about 1 mm²; and
the external diameter of the crimp joint ranges between about 1.35 and about 1.39 mm,
and the crimp joint retains each wire when each wire is subjected to a tensile force of at least about 50N.

9. A crimp joint as claimed in claim 8, wherein each wire is subjected to a tensile force of at least about 51N.

10. A crimp joint as claimed in claim 9, wherein each wire is subjected to a tensile force of at least about 51.5N.

11. A crimp joint as claimed in claim 1, forming a wiring repair in a telecommunications exchange, wherein each wire is provided as a wire in a cable comprising a five pairs of the wires, and wherein each wire in the cable is able to resist a pull-out force of about 51N applied in a longitudinal direction along the crimp joint, and wherein at least one wire is connected at a distal end from the repair joint to a termination point main distribution frame in the telecommunications exchange.

12. A crimp for use in forming a crimp joint as claimed in claim 1, the crimp comprising of a cylindrical tube of material composed of an alloy comprising copper, iron, nickel and manganese, wherein the alloy substantially comprises
nickel present in quantities of about 9 to about 11% wt,
iron present in quantities of about 1 to about 2% wt,
manganese present in quantities of about 0.3 to about 1% wt, and
lead present in quantities of up to about 0.1% wt.

13. A crimp as claimed in claim 12, wherein
the nickel is present in quantities of about 10 to about 11% wt,
the iron is present in quantities of about 1 to about 1.8% wt, and
the manganese is present in quantities of about 0.5 to about 1% wt.

14. A crimp as claimed in claim 12, wherein the crimp has dimensions capable of receiving within the tubular portion of the crimp body at least two copper wires, the crimp dimensions comprising:
an external diameter of about 1.45 to about 1.49 mm;
an internal diameter of about 1.0 to about 1.1 mm; and
a sheath thickness of about 0.35 to about 0.49 mm.

15. A crimp as claimed in claim 2, wherein the lead is present in quantities up to about 0.01% wt.

16. A crimp joint as claimed in claim 1, wherein the crimp has an internal cross-sectional diameter of about 1.0 to about 1.1 mm and the two electrically conductive wires have a cross-sectional area of about 1 mm².

17. A crimp joint as claimed in claim 2, wherein each of the two electrically conductive wires remains fixedly attached at a far end when a near end of each the wire is inserted into the cylindrical crimp body, wherein either:
the near end of each wire is inserted into the same aperture of the crimp body; or
the near end of each wire is inserted into a different aperture of the crimp body and each wire is pushed into the cylindrical crimp body sufficiently far to overlap with the other wire along the longitudinal axis of the crimp body.

18. A crimp joint as claimed in claim 17, wherein the electrically conductive wires lie substantially parallel to each other along the entire length of the crimp body.

19. A crimp joint as claimed in claim 2, wherein the crimp joint is used to repair a severed wire in a telecommunications exchange.

20. A crimp joint as claimed in claim 2, wherein
each wire end substantially comprises copper and has a diameter of at least about 1 mm²; and
the external diameter of the crimp joint ranges between about 1.35 and about 1.39 mm,
and the crimp joint retains each wire when each wire is subjected to a tensile force of at least about 50N.

21. A crimp joint as claimed in claim 2, forming a wiring repair in a telecommunications exchange, wherein each wire is provided as a wire in a cable comprising a five pairs of the wires, and wherein each wire in the cable is able to resist a pull-out force of about 51N applied in a longitudinal direction along the crimp joint, and wherein at least one wire is connected at a distal end from the repair joint to a termination point main distribution frame in the telecommunications exchange.
